(19) United States
(12) Patent Application Publication
(10) Pub. No.: US 2018/0224842 A1
(43) Pub. Date: Aug. 9, 2018

(54) CONTROL DEVICE AND METHOD OF CONTROLLING THE SAME

(71) Applicant: OMRON Corporation, Kyoto (JP)

(72) Inventor: Katsuhiko Ichimura, Yokohama-shi (JP)

(73) Assignee: OMRON Corporation, Kyoto (JP)

(21) Appl. No.: 15/815,707

(22) Filed: Nov. 17, 2017

(30) Foreign Application Priority Data
Feb. 8, 2017 (JP) 2017-021057

(51) Int. Cl. G05B 23/02; G05B 19/05

(52) U.S. Cl. CPC G05B 23/0264; G05B 19/056; G05B 2219/14067; G05B 2219/15057; G05B 2219/13004; G05B 2219/1105

(57) ABSTRACT

The invention provides a control device capable of preventing unnecessary stop in the control device including a programmable circuit unit and an arithmetic processing unit, and a method of controlling the control device. In the invention, an abnormality determination unit determines a correspondence between a position of a soft error detected by an error detection unit and a functional unit based on map information including position information (position number) in the FPGA unit corresponding to a functional unit in an FPGA unit. Further, a processor unit continues operating the control device when the abnormality determination unit determines the position of the soft error corresponds to an unused portion of the functional unit, and executes a predetermined process when the abnormality determination unit determines the position of the soft error corresponds to a used portion (e.g. a majority circuit unit or a used circuit unit) of the functional unit.

### CROSS-REFERENCE TO RELATED APPLICATION

This application claims the priority benefit of Japan application serial no. 2017-021057, filed on Feb. 8, 2017. The entirety of the above-mentioned patent application is hereby incorporated by reference herein and made a part of this specification.

### BACKGROUND OF THE INVENTION

### Field of the Invention

The disclosure relates to a control device including at least a programmable circuit unit and an arithmetic processing unit connected to the programmable circuit unit and capable of executing a user program in the arithmetic processing unit, and a control method therefor.

### Description of Related Art

Machines and facilities that are used in a large number of production sites are typically controlled by a control device such as a programmable logic controller (hereinafter also referred to as a PLC). Typically, the control program executed by such a control device is created by a user operating an information processing device called a support device and designing the control program. Such a program that is freely designed and created by the user is also called a user program.

The PLC includes a central processing unit (CPU), and a functional unit such as an input and output (I/O) unit which is responsible for inputting signals from external switches or sensors and outputting signals to external relays or actuators. The functional unit may be realized using a programmable circuit such as a field-programmable gate array (FPGA) in some cases.

However, while a user can independently build a circuit with the programmable circuit, there is a possibility of occurrence of a soft error in which information of a Config RAM (hereinafter also referred to as a CRAM) storing configuration data is changed due to radiation or the like. In particular, when a static random access memory (SRAM) is used for the CRAM, the possibility of the occurrence of the soft error is remarkable.

Therefore, Patent Document 1 discloses a configuration in which a surveillance control circuit is provided in order to detect a soft error in the FPGA. Specifically, the surveillance control circuit disclosed in Patent Document 1 includes a checking means for checking presence of an error in stored data of a CRAM provided in the FPGA, and a recording means for recording error detection information and detection date and time information when an error is detected by the checking means, and can display that the error has occurred to the outside when the information is recorded on the recording means.

However, the surveillance control circuit disclosed in Patent Document 1 can only determine whether a soft error occurs in the CRAM storing the configuration data, and needs to stop the control device even when the generated soft error is at a position unrelated to a functional unit configured in the programmable circuit. Therefore, even when a soft error that does not affect a function of the control device occurs, the control device stops such that unnecessary stop occurs.

[Patent Document 1] Japanese Patent Application Laid-Open (JP-A) No. 2014-52781

### SUMMARY OF THE INVENTION

One or some exemplary embodiments of the invention provide a control device that includes at least a programmable circuit unit and an arithmetic processing unit connected to the programmable circuit unit and is capable of executing a user program in the arithmetic processing unit, wherein the programmable circuit unit includes a storage unit that stores configuration data of a functional unit configured in the programmable circuit unit; and an error detection unit that detects a soft error of the storage unit, the arithmetic processing unit includes a memory unit that stores map information including position information in the programmable circuit unit corresponding to the functional unit in the programmable circuit unit; and an abnormality determination unit that determines a correspondence between a position of a soft error detected by the error detection unit and the functional unit on the basis of the map information, and the arithmetic processing unit continues an operation of the control device when the abnormality determination unit determines that the position of the soft error corresponds to an unused portion of the functional unit, and executes a predetermined process when the abnormality determination unit determines that the position of the soft error corresponds to a used portion of the functional unit.

One or some exemplary embodiments of the invention provide a method of controlling a control device that includes at least a programmable circuit unit and an arithmetic processing unit connected to the programmable circuit unit and is capable of executing a user program in the arithmetic processing unit, wherein the programmable circuit unit includes a storage unit that stores configuration data of a functional unit configured in the programmable circuit unit, and an error detection unit that detects a soft error of the storage unit, the arithmetic processing unit includes a memory unit that stores map information including position information in the programmable circuit unit corresponding to the functional unit in the programmable circuit unit, and the controlling method includes the steps of: determining a correspondence between a position of the soft error detected by the error detection unit and the functional unit on the basis of the map information; continuing an operation of the control device when a position of the soft error is determined to correspond to an unused portion of the functional unit; and executing a predetermined process when the position of the soft error is determined to correspond to a used portion of the functional unit.

### BRIEF DESCRIPTION OF THE DRAWINGS

FIG. 1 is a block diagram illustrating an example of a hardware configuration of a control device according to this embodiment.

FIG. 2 is a block diagram illustrating an example of soft error detection in an FPGA unit according to this embodiment.

FIG. 3 is a timing chart illustrating an example of read timing of error information in an error reading unit in this embodiment.

FIG. 4 is a diagram illustrating an example of map information in this embodiment.

FIG. 5 is a flowchart illustrating a process performed when an abnormality is detected in this embodiment.

### DESCRIPTION OF THE EMBODIMENTS

An object of one or some exemplary embodiments of the invention is to provide a control device capable of preventing unnecessary stop in the control device including at least a programmable circuit unit and an arithmetic processing unit connected to the programmable circuit unit, and capable of executing a user program in the arithmetic processing unit, and a method of controlling the control device.

According to one or some exemplary embodiments of the invention, the predetermined process is a process of stopping the programmable circuit unit. According to one or some exemplary embodiments of the invention, the predetermined process is a process of switching to a degeneration operation in which only the functional unit at the position of the soft error is stopped.

According to one or some exemplary embodiments of the invention, the functional unit includes a first functional unit including a redundant circuit and a second functional unit including a non-redundant circuit, and the arithmetic processing unit stops only a circuit at the position of the soft error and continuously operates the control device when the abnormality determination unit determines that the position of the soft error corresponds to the first functional unit, and executes a process of switching to a degeneration operation in which only the functional unit at the position of the soft error is stopped when the abnormality determination unit determines that the position of the soft error corresponds to the second functional unit.

According to one or some exemplary embodiments of the invention, the error detection unit is capable of dividing the storage unit into predetermined blocks and detecting a soft error for each block.

According to one or some exemplary embodiments of the invention, the abnormality determination unit executes the predetermined process in consideration of whether or not the position is a position of the soft error detected in the past.

According to one or some exemplary embodiments of the invention, the error detection unit performs error detection using a cyclic redundancy check (CRC) code.

According to one or some exemplary embodiments of the invention, the programmable circuit unit is a field-programmable gate array (FPGA) in which configuration data is stored in a static random access memory (SRAM) of the storage unit.

According to the control device of one or some exemplary embodiments of the invention, since the abnormality determination unit can determine whether the position of the soft error corresponds to an unused portion or a used portion of the functional unit, it is possible to prevent unnecessary stop while realizing high reliability.

Hereinafter, embodiments will be described in detail with reference to the drawings. In the drawings, the same or corresponding units are denoted with the same reference numerals.

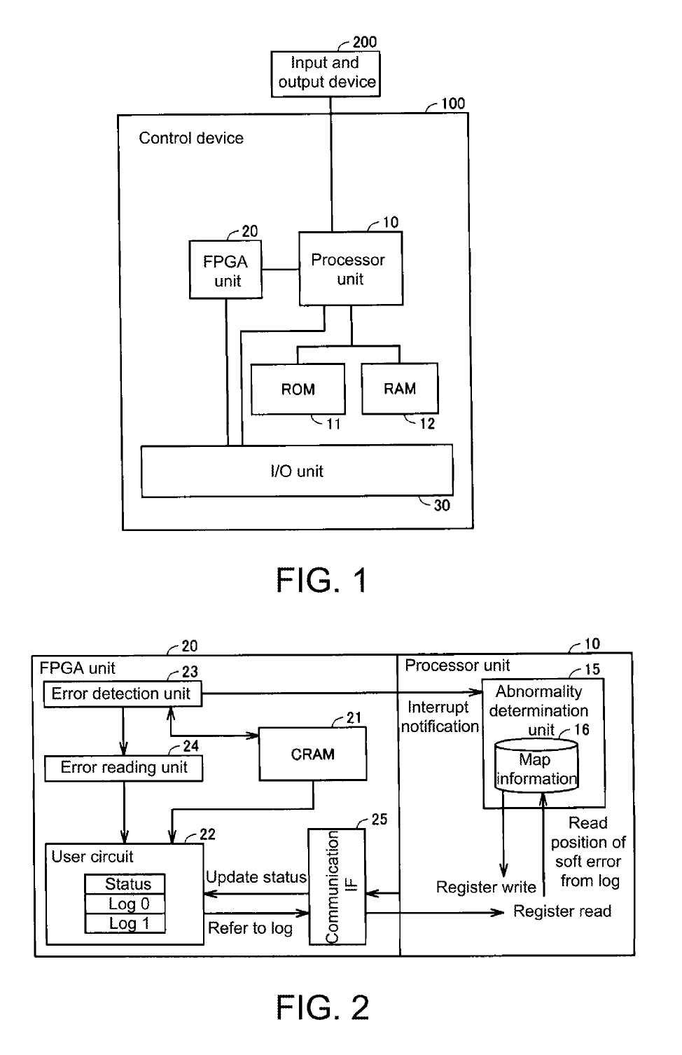

FIG. 1 is a block diagram illustrating an example of a hardware configuration of a control device according to this embodiment. The control device 100 of this embodiment is mounted, for example, using a programmable logic controller (PLC). The control device 100 applies a command value that is calculated by executing a previously stored program (a system program, a user program, or the like) to a control target (for example, a motor driver) connected via an input and output (I/O) unit 30, and acquires a state value from the control target. That is, the control device 100 can dynamically generate an appropriate command value and appropriately perform control according to a situation by feeding back the state value of the control target.

Further, as illustrated in FIG. 1, the control device 100 includes a processor unit 10, an FPGA unit 20, a ROM 11, a RAM 12, and the I/O unit 30. Each component in the control device 100 is connected by a bus.

The processor unit 10 mainly performs a process related to control or an operation of the control target by executing a program stored in the ROM 11 or the RAM 12. The FPGA unit (programmable circuit unit) 20 constitutes a functional unit and executes a specific process on digital values input from the processor unit 10. The ROM 11 stores a program for controlling the control device 100, data necessary for an operation of the program, and the like. The RAM 12 operates as a work area of the processor unit 10. The I/O unit 30 provides an interface with the control target. An input and output device 200 is a device that presents information to the user and receives an operation input from the user, such as a touch panel.

In order for the FPGA unit 20 to be configured as a functional unit that executes a specific process, a configuration for writing configuration data in a device may be required. Generally, the configuration is performed on the FPGA unit 20 immediately after power is turned on, and a functional unit capable of performing a desired circuit operation is obtained.

However, since there is a possibility of occurrence of the soft error in which information of the CRAM storing the configuration data is changed due to radiation or the like, the FPGA unit 20 performs error detection in order to detect the soft error of the CRAM. Hereinafter, soft error detection of the FPGA unit 20 will be described in detail. FIG. 2 is a block diagram illustrating an example of the soft error detection of the FPGA unit 20 in this embodiment.

The FPGA unit 20 performs configuration for writing the configuration data stored in the CRAM 21 to the device, such that a user circuit 22 constituting a functional unit is set. Here, the CRAM 21 is, for example, a static random access memory (SRAM).

The FPGA unit 20 includes an error detection unit 23 that detects the soft error of the CRAM 21. The error detection unit 23 detects the soft error using a cyclic redundancy check (CRC) code. Specifically, the error detection unit 23 adds the CRC code to each frame of the CRAM 21 and performs CRC check on a frame basis to perform detection of the soft error. The error detection unit 23 sequentially performs CRC check on a plurality of frames included in the FPGA unit 20 for determining whether or not a calculated CRC code and the added CRC code match, and performs CRC check again cyclically from the first frame when the CRC check of all the frames is completed. The error detection unit 23 may divide the frames included in the FPGA unit 20 into predetermined blocks and perform the CRC check on each block, instead of performing the CRC check on all the frames included in the FPGA unit 20 on a frame basis. For example, the error detection unit 23 divides the FPGA unit 20 into four blocks from a block constituting functional unit A to a block constituting functional unit D, and performs the CRC check on each block.

When the presence or absence of the soft error of the CRAM 21 is determined in the entire FPGA unit 20, the soft error cannot be identified even when the soft error occurs in an unused portion which does not constitute the functional unit. Therefore, in this embodiment, the functional unit constituting the FPGA unit 20 corresponding to the position in the FPGA unit 20 in which the soft error occurs (hereinafter also referred to as a position of the soft error) is specified. Specifically, an abnormality determination unit 15 of the processor unit 10 determines the functional unit corresponding to the position of the soft error detected by the error detection unit 23 on the basis of map information 16.

First, when the error detection unit 23 detects the soft error, the error detection unit 23 writes log information including content of the detected soft error to a register of the user circuit 22 via the error reading unit 24. The log information includes, for example, the position of the soft error (address information of the place of occurrence), and an error occurrence situation flag as the content of the detected soft error. Further, in the log information, sequentially, content of the soft error detected for the first time is held in log 0, and content of the soft error detected for the second time is held in log 1. Further, the error detection unit 23 writes a status including information such as the number of soft errors that have occurred or a confirmation situation of the processor unit 10 to the register of the user circuit 22.

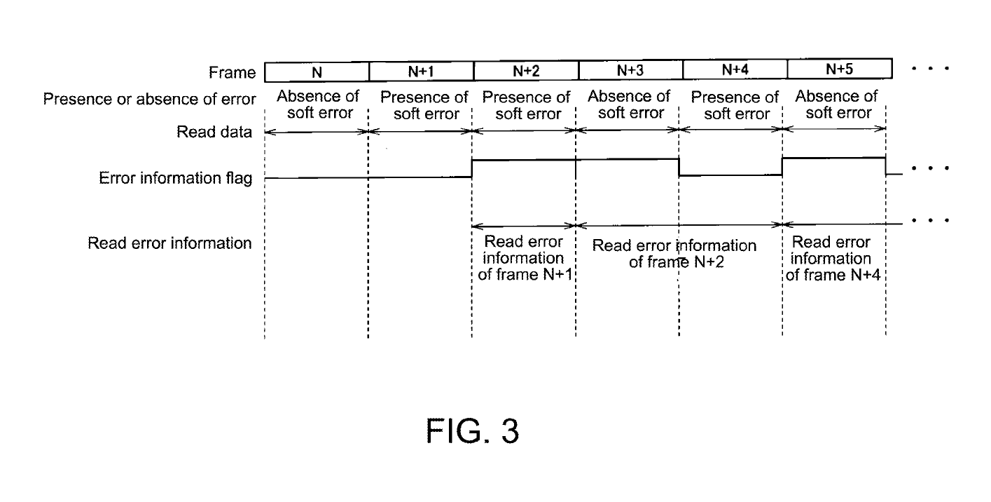

A read timing of error information in the error reading unit 24 will be described herein. FIG. 3 is a timing chart illustrating an example of the read timing of the error information in the error reading unit 24 in this embodiment. In the timing chart illustrated in FIG. 3, timings from a frame N to a frame N+5 of the CRAM 21 are illustrated. The error detection unit 23 detects a soft error in a frame N+1, a frame N+2, and a frame N+4 of the CRAM 21. Even when the error detection unit 23 detects the soft error in the frame N+1 of the CRAM 21, an error information flag does not enter an ON state in a data read period of the frame N+1. In the error detection unit 23, the error information flag for the soft error detected in the frame N+1 enters an ON state in the next frame N+2. Therefore, the error reading unit 24 reads the error information of the soft error detected in the frame N+1 from the error detection unit 23 in the data read period of the frame N+2.

Similarly, even when the error detection unit 23 detects the soft error in the frame N+2 of the CRAM 21, the error information flag does not enter an ON state in a data read period of the frame N+2. In the error detection unit 23, the error information flag for the soft error detected in the frame N+2 enters an ON state in the next frame N+3. Therefore, the error reading unit 24 reads the error information of the soft error detected in the frame N+2 from the error detection unit 23 in the data read period of the frame N+3. Since the soft error is not detected in the frame N+3 of the CRAM 21, the error information flag enters an OFF state in the data read period of the frame N+4. However, since the error reading unit 24 does not need to read the error information of the soft error detected in the frame N+3 in the data read period of the frame N+4, the error reading unit 24 continuously reads the error information of the soft error detected in the frame N+2.

Referring back to FIG. 2, when the error detection unit 23 detects the soft error, the error detection unit 23 transmits an interrupt notification to the processor unit 10. When the processor unit 10 receives the interrupt notification, a process in the abnormality determination unit 15 is started. The abnormality determination unit 15 reads the position of the soft error from the log information held in the user circuit 22 by referring to the log information via a communication IF (Interface) 25 of the FPGA unit 20. The abnormality determination unit 15 determines the functional unit to which the read position of the soft error corresponds on the basis of the map information 16. The read position of the soft error includes a position number. In the map information 16, information on the functional unit corresponding to this position number is stored. That is, the map information 16 includes position information (position number) in the FPGA unit 20 corresponding to the functional unit in the FPGA unit 20.

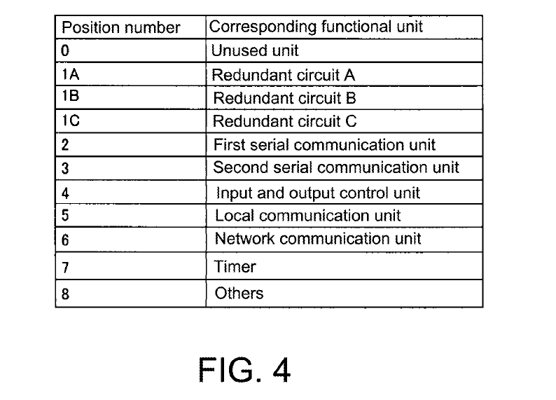

FIG. 4 is a diagram illustrating an example of the map information 16 in this embodiment. In the map information 16, information on position numbers 0 to 8 and names of functional units corresponding thereto is stored. For position number 0, the corresponding functional unit is an unused portion. For position number 1, the corresponding functional unit is a redundant circuit unit. More specifically, position number 1A corresponds to a redundant circuit A, position number 1B corresponds to a redundant circuit B, and position number 1C corresponds to a redundant circuit C. For position number 2, the corresponding functional unit is a first serial communication unit. For position number 3, a corresponding functional unit is a second serial communication unit. For position number 4, the corresponding functional unit is an input and output control unit. For position number 5, the corresponding functional unit is a local communication unit. For position number 6, the corresponding functional unit is a network communication unit. For position number 7, the corresponding functional unit is a functional unit of a timer. For position number 8, the corresponding functional unit is another functional unit.

When the abnormality determination unit 15 has determined the functional unit to which the read position of the soft error corresponds on the basis of the map information 16, the abnormality determination unit 15 writes that information as the status held in the user circuit 22 to update the status. For example, the abnormality determination unit 15 writes information regarding which of the unused portion, the redundant circuit unit, and the used circuit unit is the functional unit determined in the read log information, to the status to update the status. In the status, unanalyzed information is stored in the log information that has not yet been analyzed by the abnormality determination unit 15. Therefore, when the abnormality determination unit 15 reads the position of the soft error from the log information, the abnormality determination unit 15 can identify the log information that has not yet been analyzed by referring to the status.

The map information 16 is formed when configuration data for setting functional units included in the user circuit 22 is created, and is stored in a memory unit (for example, the RAM 12) of the processor unit 10.

In the related art, since the functional unit to which the read position of the soft error corresponds cannot be specified, the control device is mechanically stopped when the soft error is detected for the purpose of preventing a fraudulent operation of the FPGA. Therefore, there is a problem in that the control device is stopped even when a soft error not affecting a function (a soft error occurring in the unused portion) occurs, and unnecessary stop occurs. Further, the unnecessary stop can be prevented by separately diagnosing the presence or absence of the fraudulent operation using a diagnosis program or the like when a soft error occurs, but there are problems in that a detection rate of the presence or absence of the fraudulent operation of the diagnosis program or the like is low and a period for executing the diagnosis may be necessary.

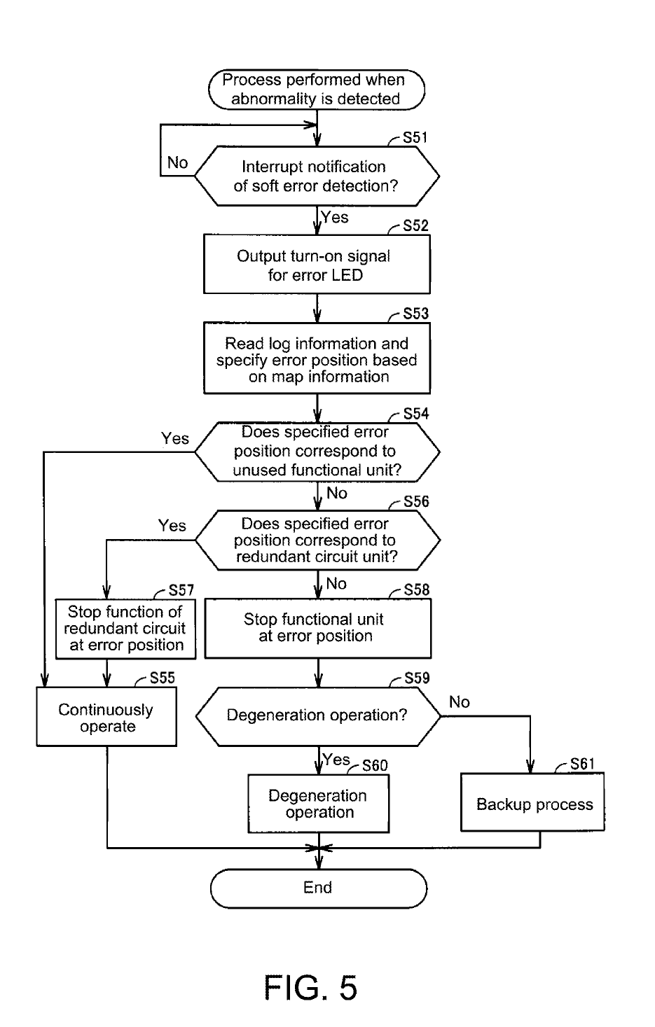

Therefore, as described above, the abnormality determination unit 15 can determine the functional unit to which the read position of the soft error corresponds on the basis of the map information 16, thereby preventing unnecessary stop. Specifically, the process performed when an abnormality is detected in this embodiment will be described below. FIG. 5 is a flowchart illustrating the process performed when an abnormality is detected in this embodiment.

First, the processor unit 10 determines whether or not the interrupt notification for soft error detection has been received from the error detection unit 23 (step S51). When the processor unit 10 determines that the interrupt notification is not received (step S51: NO), the processor unit 10 continues to wait for reception of the interrupt notification and executes a normal process. When the processor unit 10 determines that the interrupt notification has been received (step S51: YES), the processor unit 10 outputs a turn-on signal for turning on an error LED (not illustrated) (step S52). The error LED is a notification means that is provided in the control device, a controller connected to the control device, or the like, and is for notifying the user of the occurrence of the error. The notification means is not limited to the error LED, and may be a display device such as an LCD, a speaker for outputting error sound, or the like.

Then, the processor unit 10 (particularly, the abnormality determination unit 15) reads the log information from the user circuit 22 and specifies the error position on the basis of the map information 16 (step S53). Here, specifying the error position is specifying the functional unit configured in the FPGA unit 20 to which the position of the soft error detected by the error detection unit 23 corresponds. For example, when the position of the soft error is position number 4 (see FIG. 4), the abnormality determination unit 15 determines that the functional unit at the specified error position is the input and output control unit.

Next, the processor unit 10 (particularly, the abnormality determination unit 15) determines whether or not the specified error position corresponds to an unused functional unit (step S54). For example, when the position of the soft error is position number 0 (sec FIG. 4), the abnormality determination unit 15 determines that the functional unit at the specified error position is an unused portion. When the processor unit 10 determines that the specified error position corresponds to an unused functional unit (step S54: YES), the processor unit 10 continuously operates the control device 100 (step S55). That is, even when the soft error occurs in the unused functional unit, the control device 100 can function normally, and therefore the control device 100 continuously performs the operation without being stopped, thereby preventing unnecessary stop even when the soft error occurs. The processor unit 10 continuously operates the control device 100 in step S55 and then ends the process performed when an abnormality is detected.

Then, when the processor unit 10 determines that the specified error position is not an unused functional unit (step S54: NO), the processor unit 10 (particularly, the abnormality determination unit 15) determines whether or not the specified error position corresponds to a redundant circuit functional unit (step S56). Here, the redundant circuit unit is a circuit unit that is redundant, and circuits having the same function are formed in a duplicated manner. For example, a duplicated circuit unit in which circuits having the same functions are duplicated and a redundant circuit unit in which circuits having the same function are triplicated and a majority vote is performed are included. In the example illustrated in FIG. 4, circuits having the same functions are triplicated as redundant circuit A, redundant circuit B, and redundant circuit C.

When the processor unit 10 determines that the specified error position corresponds to a redundant circuit functional unit (step S56: YES), the processor unit 10 stops the function of the redundant circuit at the error position (step S57). For example, when the position of the soft error is position number IA (see FIG. 4), the abnormality determination unit 15 stops the function of the redundant circuit A at the specified error position. When the soft error has occurred in the redundant circuit unit, the processor unit 10 stops only the circuit in which the soft error has occurred in the redundant circuit unit. That is, when the redundant circuit unit is a redundant circuit unit in triplicate with redundant circuit A, redundant circuit B, and redundant circuit C, the processor unit 10 stops only a function of redundant circuit A, and executes processes in the remaining redundant circuits B and C. Thereafter, the processor unit 10 continuously operates the control device 100 with redundant circuit B and redundant circuit C (step S55). That is, even when the soft error occurs in some of the circuits in the redundant circuit unit, the control device 100 can function normally, and therefore the control device 100 continuously performs the operation without being stopped, thereby preventing unnecessary stop even when the soft error occurs. The processor unit 10 ends the process performed when an abnormality is detected after continuously operating the control device 100 in step S55.

Then, when the processor unit 10 determines that the specified error position does not correspond to the redundant circuit unit as a functional unit (step S56: NO), the processor unit 10 stops the functional unit at the error position (step S58). For example, when the position of the soft error is position number 2 (see FIG. 4), the abnormality determination unit 15 determines that the functional unit at the specified error position is the first serial communication unit. The processor unit 10 stops only the functional unit of the first serial communication unit in which the soft error has occurred.

The processor unit 10 determines whether or not the control device 100 can perform a degeneration operation in a state in which the processor unit 10 stops only the circuit in which the soft error has occurred in step S57 (step S59). Specifically, the processor unit 10 prepares degeneration operation information indicating whether the degeneration operation is “possible” or “not possible” when the soft error has occurred, as a table in advance, reads the degeneration operation information corresponding to the functional unit stopped in step S58 from the table, and performs the determination. The processor unit 10 can maintain the operation of the control device 100 even when there is no functional unit stopped in step S58, and registers a functional unit that does not affect processes of other functional units in the table as degeneration operation “possible.” For example, when a process for the device connected to the second serial communication unit is not affected even if only the functional unit of the first serial communication unit is stopped, the function of the first serial communication unit is degenerated and the operation can be continued. When the processor unit 10 determines that the control device 100 can perform the degeneration operation (step S59: YES), the processor unit 10 causes the control device 100 to perform the degeneration operation in a state in which the processor unit 10 stops some of the functional units in step S57 (step S60). By causing the control device 100 to perform the degeneration operation even when some of the functional units cannot be used, unnecessary stop is prevented even when the soft error occurs. The processor unit 10 ends the process performed when an abnormality is detected after causing the control device 100 to perform the degeneration operation in step S60.

Next, when the processor unit 10 determines that the control device 100 cannot perform the degeneration operation (step S59: NO), the processor unit 10 starts a backup process to stop the control device 100 (step S61). For example, when the position of the soft error is position number 5 (see FIG. 4), the abnormality determination unit 15 determines that the functional unit at the specified error position is the local communication unit. When the soft error occurs in the local communication unit, the processor unit 10 concludes that the operation of the control device 100 cannot be maintained, and forcibly stops the FPGA unit 20. When the FPGA unit 20 is stopped, it may be needed to perform a process of storing, for example, data required to restart the FPGA unit 20 in the RAM 12, and therefore, the processor unit 10 starts the backup process in step S61. The processor unit 10 forcibly stops the FPGA unit 20 after completing the backup process in step S61.

When the processor unit 10 performs the backup process in step S61 and forcibly stops the FPGA unit 20, the processor unit 10 can perform reconfiguration on the FPGA unit 20 to reconfigure a functional unit capable of performing a desired circuit operation and perform restart. After the processor unit 10 performs the backup process in step S61 and forcibly stops the FPGA unit 20, the processor unit 10 ends the process performed when an abnormality is detected.

As described above, in the control device 100 according to this embodiment, the abnormality determination unit 15 determines the correspondence between the position of the soft error detected by the error detection unit 23 and the functional unit on the basis of the map information indicating the correspondence between the position (position number) in the FPGA unit 20 and the functional unit in the FPGA unit 20. Further, when the abnormality determination unit 15 determines that the position of the soft error corresponds to an unused portion of the functional unit, the processor unit 10 continues to operate the control device 100, and when the abnormality determination unit 15 determines that the position of the soft error corresponds to a used portion (for example, a redundant circuit unit or a used circuit unit) of the functional unit, the processor unit 10 performs a predetermined process. Therefore, the control device 100 can prevent unnecessary stop while realizing high reliability even when the soft error occurs in the FPGA unit 20.

Further, the predetermined process may be a process of stopping the FPGA unit 20 or may be a process of switching to the degeneration operation in which only the functional unit at the position of the soft error is stopped. By causing the control device 100 to perform the degeneration operation, it is also possible to prevent unnecessary stop. The predetermined process may be a process of temporarily stopping the operation of the control device 100, a process of notifying that the software error has occurred, a process of performing an operation in which the occurrence of the soft error has been recorded, or the like.

Further, when the abnormality determination unit 15 determines that the position of the soft error corresponds to a redundant circuit (for example, a redundant circuit unit), the processor unit 10 stops only the redundant circuit at the position of the soft error and continuously operates the control device. Further, when the abnormality determination unit 15 determines that the position of the soft error corresponds to a non-redundant circuit (for example, a used circuit unit), and when the processor unit 10 determines that the degeneration operation can be performed, the processor unit 10 executes a process of switching to the degeneration operation in which only the functional unit at the position of the soft error is stopped. Therefore, the control device 100 can prevent unnecessary stop while realizing high reliability even when the soft error occurs in the redundant circuit of the FPGA unit 20.

Further, in the method of controlling the control device 100 according to this embodiment, a step (step S53) of determining correspondence between the position of the soft error detected by the error detection unit 23 and the functional unit is performed on the basis of the map information. Further, in the control method, a step (step S55) of continuing the operation of the control device 100 when the position of the soft error is determined to correspond to the unused portion of the functional unit is performed. Further, in the control method, a step (steps S58 and S60) of executing the predetermined process when the position of the soft error is determined to correspond to a used portion (for example, the redundant circuit unit and the used circuit unit) of the functional unit is performed. Therefore, the method of controlling the control device 100 can prevent unnecessary stop while realizing high reliability even when the soft error occurs in the FPGA unit 20.

### Modification Example

(1) The case in which the error detection unit 23 according to this embodiment performs the detection of the soft error using all the frames included in the FPGA unit 20 as one unit has been described, but the invention is not limited thereto. For example, the error detection unit 23 may divide the CRAM 21 into predetermined blocks and detect the soft error for each block. The error detection unit 23 can detect the soft error without waiting for detection results of all the frames by dividing the CRAM 21 into a plurality of blocks and detecting the soft error.

(2) The case in which the processor unit 10 according to this embodiment executes the predetermined process when the abnormality determination unit 15 determines that the position of the soft error corresponds to the used portion (for example, a redundant circuit unit and a used circuit unit) of the functional unit has been described, but the invention is not limited thereto. For example, the processor unit 10 may execute the predetermined process in consideration of whether or not the position is a position of the soft error detected in the past on the basis of the log information of the user circuit 22. Therefore, when the soft error occurs at the same position, the control device 100 can be stopped and unnecessary stop can be prevented.

(3) The case in which the processor unit 10 according to this embodiment continuously operates the control device 100 in a state in which the processor unit 10 stops only the redundant circuit in which the soft error has occurred when the functional unit at the error position is the redundant circuit unit has been described, but the invention is not limited thereto. For example, when the functional unit at the error position is three or more redundant circuits, the processor unit 10 may cause the degeneration operation to be performed when the number of redundant circuits to be stopped due to the occurrence of the soft error is a majority.

(4) The case in which the processor unit 10 according to this embodiment executes the predetermined process when the soft error occurs in the used circuit unit has been described, but the invention is not limited thereto. For example, the function of the used circuit unit may be weighted and the processor unit 10 may change a process to be executed on the basis of the weighting when a soft error occurs in the used circuit unit. Specifically, the processor unit 10 forcibly stops the FPGA unit 20 when a soft error occurs in a used circuit unit having a function of a local communication unit, but causes the degeneration operation to be performed when a soft error occurs in a used circuit unit having a function of a serial communication unit.

(5) In the control device 100 according to this embodiment, the process performed when an abnormality occurs due to the soft error in the configurations illustrated in FIG. 1 and FIG. 2 has been described. However, this configuration is merely an example, and any configuration may be adopted as long as the same process performed when an abnormality occurs can be performed.

The embodiments disclosed herein should be considered illustrative and not restrictive in all respects. The scope of the invention is shown by the claims rather than the above description, and it is intended that all modifications within the meaning and scope equivalent to the claims are included.

What is claimed is:

1. A control device, comprising at least a programmable circuit unit and an arithmetic processing unit connected to the programmable circuit unit, capable of executing a user program in the arithmetic processing unit,
wherein the programmable circuit unit comprises:
a storage unit, storing configuration data of a functional unit configured in the programmable circuit unit; and
an error detection unit, detecting a soft error of the storage unit,
the arithmetic processing unit comprises:
a memory unit, storing map information including position information in the programmable circuit unit corresponding to the functional unit in the programmable circuit unit; and
an abnormality determination unit, determining a correspondence between a position of the soft error detected by the error detection unit and the functional unit on the basis of the map information, and
the arithmetic processing unit comprises:
continuing an operation of the control device when the abnormality determination unit determines that the position of the soft error corresponds to an unused portion of the functional unit, and
executing a predetermined process when the abnormality determination unit determines that the position of the soft error corresponds to a used portion of the functional unit.

2. The control device according to claim 1, wherein the predetermined process is a process of stopping the programmable circuit unit.

3. The control device according to claim 1, wherein the predetermined process is a process of switching to a degeneration operation in which only the functional unit at the position of the soft error is stopped.

4. The control device according to claim 1,
wherein the functional unit comprises a first functional unit including a redundant circuit and a second functional unit including a non-redundant circuit, and
the arithmetic processing unit comprises:
stopping only a circuit at the position of the soft error and continuously operating the control device when the abnormality determination unit determines that the position of the soft error corresponds to the first functional unit, and
executing a process of switching to a degeneration operation in which only the functional unit at the position of the soft error is stopped when the abnormality determination unit determines that the position of the soft error corresponds to the second functional unit.

5. The control device according to claim 1, wherein the error detection unit comprises dividing the storage unit into a plurality of predetermined blocks and detecting a soft error for each of the blocks.

6. The control device according to claim 1, wherein the abnormality determination unit executes the predetermined process in consideration of whether or not the position is a position of the soft error detected in the past.

7. The control device according to claim 1, wherein the error detection unit performs error detection using a cyclic redundancy check (CRC) code.

8. The control device according to claim 1, wherein the programmable circuit unit is a field-programmable gate array (FPGA) in which configuration data is stored in a static random access memory (SRAM) of the storage unit.

9. A method of controlling a control device that comprises at least a programmable circuit unit and an arithmetic processing unit connected to the programmable circuit unit and is capable of executing a user program in the arithmetic processing unit,
wherein the programmable circuit unit comprises a storage unit that stores a configuration data of a functional unit configured in the programmable circuit unit, and an error detection unit that detects a soft error of the storage unit,
the arithmetic processing unit includes a memory unit that stores a map information including a position information in the programmable circuit unit corresponding to the functional unit in the programmable circuit unit, and
the controlling method comprises steps of:
determining a correspondence between a position of the soft error detected by the error detection unit and the functional unit on the basis of the map information;
continuing an operation of the control device when a position of the soft error is determined to correspond to an unused portion of the functional unit; and
executing a predetermined process when the position of the soft error is determined to correspond to a used portion of the functional unit.
